(19) United States
(12) Patent Application Publication
(10) Pub. No.: US 2015/0287096 A1
(43) Pub. Date: Oct. 8, 2015

(54) BID CONTROL THROUGH SEMANTIC SIGNALS EXPRESSED IN NATURAL LANGUAGE

(71) Applicant: Google Inc., Mountain View, CA (US)

(72) Inventor: Henrik Jacobsson, Zurich (CH)

(73) Assignee: Google Inc., Mountain View, CA (US)

(21) Appl. No.: 14/245,850

(22) Filed: Apr. 4, 2014

(51) Int. Cl. G06Q 30/02

(52) U.S. Cl. CPC G06Q 30/0275; G06Q 30/0254

(57) ABSTRACT

Methods, systems, and apparatus include computer programs encoded on a computer-readable storage medium for managing keyword independent signals. A method includes: receiving a request for content; evaluating an inventory; identifying one or more eligible content items; identifying a first content item and determining that the first content item is a match for the request; determining that the first content item is associated with a campaign that includes a selection criterion that requires satisfaction of a keyword independent signal; evaluating the request to determine that the request satisfies the keyword independent signal; retrieving a bid and a bid modifier associated with the first content item; applying the bid modifier to the bid to create a modified bid; and using the modified bid in an auction with bids associated with other eligible content items.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for presenting information for keyboard independent signals to a content sponsor. The method includes: identifying a campaign for distributing one or more content items, the campaign being associated with a content sponsor and having selection criteria for use in determining when to present the one or more content items in response to received requests for content, wherein the selection criteria includes a plurality of keywords; identifying historical traffic associated with the campaign, the historical traffic representative of occurrences of when an impression of one of the one or more content items was delivered in response to a received request, the historical traffic including data that indicates a received query, any interaction and conversion information associated with the impression; evaluating the historical traffic to identify at least one keyword independent signal that is statistically significant in terms of one or more metrics for measuring effectiveness of the campaign; determining a natural language expression that describes the at least one keyword independent signal; presenting the determined natural language expression for the at least one keyword independent signal to the content sponsor; receiving a bid modifier to be used in association with a real time occurrence of traffic that satisfies the at least one keyword independent signal; and storing the bid modifier in association with the campaign.

These and other implementations can each optionally include one or more of the following features. The campaign can be an advertisement campaign and the natural language expression can be presented in an interface to an advertiser associated with the campaign as part of a campaign modification tool. Evaluating the historical traffic can include, for a given traffic item, evaluating one or more of the received query, a location of the requesting device, or a session in which the query was submitted. Evaluating the historical traffic can include determining an abstraction from the received query and using the abstraction to determine the natural language expression. Evaluating the historical traffic can include determining a plurality of abstractions each associated with a query submitted by a user during a session associated with the received query. Determining a natural language expression can include determining a common abstraction from the determined plurality of abstractions. Evaluating the historical traffic can include determining an intent associated with the received query. Determining a natural language expression can include using the intent to determine the natural language expression. Evaluating the historical traffic can include determining a plurality of intents each associated with a query submitted by a user during a session associated with the received query. Determining a natural language expression can include determining a common intent from the determined plurality of intents. The bid modifier can be an adjustment to a bid that is to be applied to a single auction in which the selection criteria have determined to be satisfied along with the determined natural language expression. A bid associated with the campaign can be evaluated based on the keyword independent signal. A suggestion for the bid modifier can be created. The bid modifier suggestion along with the natural language expression can be presented. A plurality of keyword independent signals can be identified, bid modifiers can be determined for each signal, and natural language expressions and associated bid modifier suggestions can be presented for top ranked keyword independent signals.

In general, another innovative aspect of the subject matter described in this specification can be implemented in methods that include a method for applying a bid modifier associated with a keyword independent signal. The method includes: receiving a request for content, the request including one or more keywords for use in determining eligible content items from an inventory of available content items; evaluating the inventory including comparing the one or more keywords to selection keywords that are associated with each available content item in inventory; identifying one or more eligible content items based on the evaluating; identifying a first content item of the eligible content items including determining that the first content item is a match for the request based on the one or more keywords and selection keywords associated with the first content item; determining that the first content item is associated with a campaign that includes a further selection criterion that requires satisfaction of a keyword independent signal; evaluating the request to determine that the request satisfies the keyword independent signal; retrieving a bid and a bid modifier associated with the first content item; applying the bid modifier to the bid to create a modified bid; using the modified bid in an auction with bids associated with other eligible content items; and selecting the first content item for delivery responsive to the request based on the results of the auction when the modified bid results in the first content item winning the auction.

These and other implementations can each optionally include one or more of the following features. Evaluating the request can include evaluating one or more of the request, a location of a requesting device, or a session associated with the request. Evaluating the request can include determining an abstraction based on the request and using the abstraction to determine satisfaction of the keyword independent signal. Evaluating the request can include determining an intent based on the request and using the intent to determine satisfaction of the keyword independent signal. Modified bid use information that describes the use of the modified bid can be stored. A report that includes the modified bid use information can be provided to a content sponsor associated with the campaign. The report can include selectable controls for increasing, decreasing, or deselecting a bid modifier. An indication of a selected control can be received and a corresponding action to the bid modifier can be applied based on the indication.

In general, another aspect of the subject matter described in this specification can be implemented in computer program products. A computer program product is tangibly embodied in a computer-readable storage device and comprises instructions. The instructions, when executed by a processor, cause the processor to: identify a campaign for distributing one or more content items, the campaign being associated with a content sponsor and having selection criteria for use in determining when to present the one or more content items in response to received requests for content, wherein the selection criteria includes a plurality of keywords; identify historical traffic associated with the campaign, the historical traffic representative of occurrences of when an impression of one of the one or more content items was delivered in response to a received request, the historical traffic including data that indicates a received query, any interaction and conversion information associated with the impression; evaluate the historical traffic to identify at least one keyword independent signal that is statistically significant in terms of one or more metrics for measuring effectiveness of the campaign; determine a natural language expression that describes the at least one keyword independent signal; present the determined natural language expression for the at least one keyword independent signal to the content sponsor; receive a bid modifier to be used in association with a real time occurrence of traffic that satisfies the at least one keyword independent signal; and store the bid modifier in association with the campaign.

The instructions, when executed by the processor, can further cause the processor to: receive a request for content, the request including one or more keywords for use in determining eligible content items from an inventory of available content items; evaluate the inventory including comparing the one or more keywords to selection keywords that are associated with each available content item in inventory; identify one or more eligible content items based on the evaluating; identify a first content item of the eligible content items including determining that the first content item is a match for the request based on the one or more keywords and selection keywords associated with the first content item; determine that the first content item is associated with a campaign that includes a further selection criterion that requires satisfaction of a keyword independent signal; evaluate the request to determine that the request satisfies the keyword independent signal; retrieve a bid and a bid modifier associated with the first content item; apply the bid modifier to the bid to create a modified bid; use the modified bid in an auction with bids associated with other eligible content items; and select the first content item for delivery responsive to the request based on the results of the auction when the modified bid results in the first content item winning the auction.

In general, another aspect of the subject matter described in this specification can be implemented in systems. A system includes one or more processors and one or more memory elements including instructions. The instructions, when executed, cause the one or more processors to: receive a request for content, the request including one or more keywords for use in determining eligible content items from an inventory of available content items; evaluate the inventory including comparing the one or more keywords to selection keywords that are associated with each available content item in inventory; identify one or more eligible content items based on the evaluating; identify a first content item of the eligible content items including determining that the first content item is a match for the request based on the one or more keywords and selection keywords associated with the first content item; determine that the first content item is associated with a campaign that includes a further selection criterion that requires satisfaction of a keyword independent signal; evaluate the request to determine that the request satisfies the keyword independent signal; retrieve a bid and a bid modifier associated with the first content item; apply the bid modifier to the bid to create a modified bid; use the modified bid in an auction with bids associated with other eligible content items; and select the first content item for delivery responsive to the request based on the results of the auction when the modified bid results in the first content item winning the auction.

The instructions, when executed, can further cause the one or more processors to: identify a campaign for distributing one or more content items, the campaign being associated with a content sponsor and having selection criteria for use in determining when to present the one or more content items in response to received requests for content, wherein the selection criteria includes a plurality of keywords; identify historical traffic associated with the campaign, the historical traffic representative of occurrences of when an impression of one of the one or more content items was delivered in response to a received request, the historical traffic including data that indicates a received query, any interaction and conversion information associated with the impression; evaluate the historical traffic to identify at least one keyword independent signal that is statistically significant in terms of one or more metrics for measuring effectiveness of the campaign; determine a natural language expression that describes the at least one keyword independent signal; present the determined natural language expression for the at least one keyword independent signal to the content sponsor; receive a bid modifier to be used in association with a real time occurrence of traffic that satisfies the at least one keyword independent signal; and store the bid modifier in association with the campaign.

Particular implementations may realize none, one or more of the following advantages. A content sponsor can adjust a bid based on a keyword independent signal. Adjusting a bid based on a keyword independent signal can be a less complex and more accurate form of campaign management than configuring bids for multiple keywords. Top-ranked keyword independent signals associated with a campaign can be presented to a content sponsor. A content sponsor can view a performance report related to keyword independent signals.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for presenting content.

FIG. 2 is a block diagram of an example system for determining and responding to keyword independent signals.

FIG. 3 illustrates an example campaign management user interface

FIG. 4 illustrates an example performance report for campaign activity associated with a keyword independent signal

FIG. 5 is a flowchart of an example process for presenting information for keyboard independent signals to a content sponsor

FIG. 6 is a flowchart of an example process for applying a bid modifier associated with a keyword independent signal.

FIG. 7 is a block diagram of computing devices that may be used to implement the systems and methods described in this document, as either a client or as a server or plurality of servers.

Like reference numbers and designations in the various drawings indicate like elements.

### DETAILED DESCRIPTION

A content server can evaluate historical traffic for a campaign to identify one or more keyword independent signals that are statistically significant in terms of one or more metrics for measuring effectiveness of the campaign. The content server can determine a natural language expression for each of one or more keyword independent signals and can present the determined natural language expression(s) to a content sponsor associated with the campaign. A bid modifier to be used in association with a real time occurrence of traffic that satisfies the at least one keyword independent signal can be received from the content sponsor and the bid modifier can be stored in association with the campaign.

The content server can determine, in response to a received request for content, that a content item associated with the campaign includes a selection criterion that requires satisfaction of a keyword independent signal. The content server can evaluate the request to determine that the request satisfies the keyword independent signal. The content server can retrieve a bid and a bid modifier associated with the content item and can apply the bid modifier to the bid to create a modified bid. The modified bid can be used in an auction with bids associated with other eligible content items and the content item can be selected for delivery responsive to the request based on the results of the auction when the modified bid results in the content item winning the auction.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from a content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

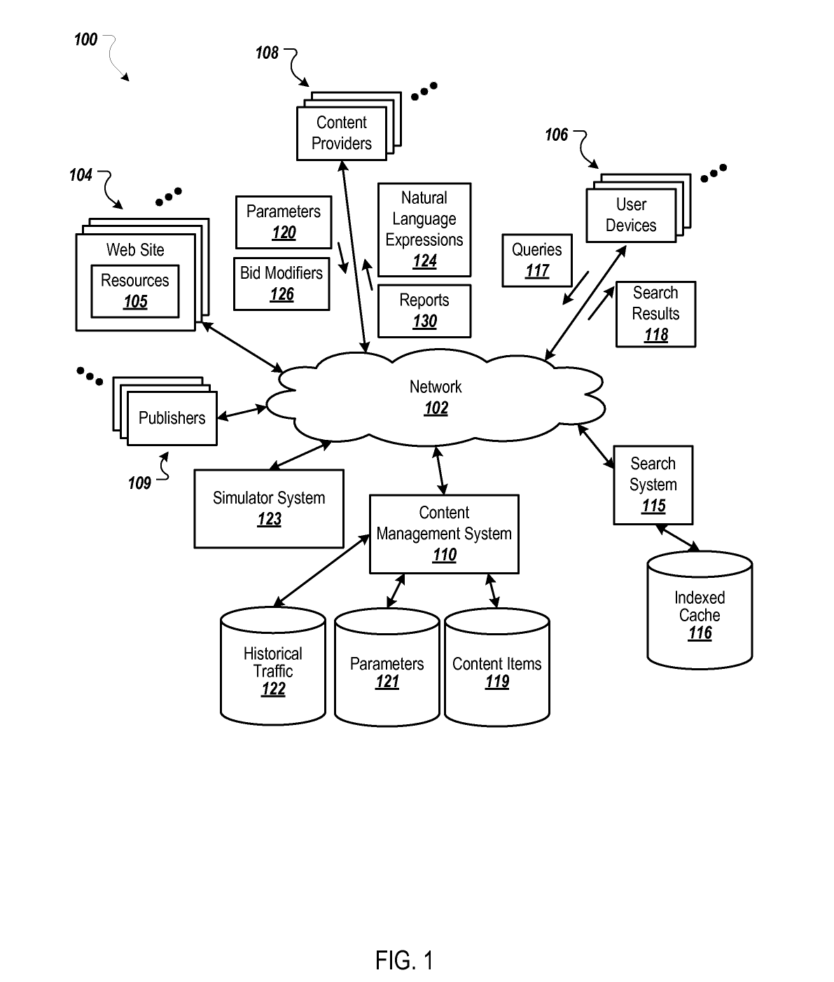

FIG. 1 is a block diagram of an example environment 100 for presenting content. The example environment 100 includes a network 102, such as a local area network (LAN), a wide area network (WAN), the Internet, or a combination thereof. The network 102 connects websites 104, user devices 106, content providers 108, publishers 109, and a content management system 110. The example environment 100 may include many thousands of websites 104, user devices 106, content providers 108, and publishers 109. The content management system 110 may be used for selecting and providing content in response to requests for content. The content providers 108 can be, for example, advertisers. Other types of content providers are possible.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a publisher 109, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as scripts).

A user device 106 is an electronic device that is under control of a user and is capable of requesting and receiving resources 105 over the network 102. Example user devices 106 include personal computers, tablet computers, mobile communication devices (e.g., smartphones), televisions, set top boxes, personal digital assistants and other devices that can send and receive data over the network 102. A user device 106 typically includes one or more user applications, such as a web browser, to facilitate the sending and receiving of data over the network 102. The web browser can interact with various types of web applications, such as a game, a map application, or an e-mail application, to name a few examples.

A user device 106 can request resources 105 from a website 104. In turn, data representing the resource 105 can be provided to the user device 106 for presentation by the user device 106. User devices 106 can also submit search queries 117 to the search system 115 over the network 102. In response to a search query 117, the search system 115 can, for example, access the indexed cache 116 to identify resources 105 that are relevant to the search query 117. The search system 115 identifies the resources 105 in the form of search results 118 and returns the search results 118 to the user devices 106 in search results pages. A search result 118 is data generated by the search system 115 that identifies a resource 105 that is responsive to a particular search query 117, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource 105 or a search query 117 for which search results 118 are requested can also be provided to the content management system 110 to facilitate identification of content that is relevant to the resource 105 or search query 117. An identifier (e.g., cookie) associated with the user device 106 can be received with the request for content.

Based, for example, on data included in the request for content, the content management system 110 can select (e.g., from a content items data store 119) content items that are eligible to be provided in response to the request. One or more selected content items can be provided to the user device 106 in association with providing an associated resource 105 or search results 118. The provided content item(s) can be presented on the user device 106, in one or more respective slots.

The content management system 110 can, for example, select a content item having characteristics matching the characteristics of a given slot. As another example, content items having selection criteria (e.g., keywords) that match resource keywords in the search query 117 or keywords included in the search results 118 may be selected as eligible content items by the content management system 110. As yet another example, the content management system 110 can identify a content item in the content items datastore 119 that is associated with a keyword that matches a keyword included in a user profile associated with the requesting user device 106. The identified content item can be selected by the content management system 110 and provided to the requesting user device 106.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). A quality score can be determined, for example, based on a quality of match between, for example, a keyword associated with a content item and keywords associated with a resource that includes the slot associated with the request. As another example, a quality score can be determined based on a quality of match between a keyword associated with a content item and keywords included in a user device profile associated with the requesting user device.

The content items provided to the requesting user device 106, and optionally user interactions (e.g., click-throughs, conversions) with the content items, can be tracked by various mechanisms (e.g., using cookies, or pixel callbacks), sent back to the content management system 110, and stored in a historical traffic database 122, in association with the content provider 108 associated with a respective content item. Such tracking can be enabled by various user opt-in processes. Performance of particular keywords, content groups, and campaigns can be measured based on various performance metrics, such as cost per action (e.g., click or conversion), conversion length (e.g., number of clicks between initial impression and conversion), click through rate, etc.

A conversion can be said to occur when a user performs a particular action related to a content item provided with a resource 105 or search results page. What constitutes a conversion may vary from case-to-case and can be determined in a variety of ways. For example, a conversion may occur when a user clicks on a content item, is referred to a web page, and consummates a purchase there before leaving that web page. A conversion can also be defined by a content provider 108 to be any measurable/observable user action, such as downloading a white paper, navigating to at least a given depth of a website, viewing at least a certain number of web pages, spending at least a predetermined amount of time on a website or web page, registering on a website, or commenting upon a content item where the comments are visible to others. Other actions that constitute a conversion can also be used.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 120 which define a content campaign. The content campaign can be created and activated for the content provider 108 according to the parameters 120 specified by the content provider 108. The campaign parameters 120 can be stored in a campaign database 121. Campaign parameters 120 can include, for example, a campaign name, a preferred content network for placing content, a budget for the campaign, start and end dates for the campaign, a schedule for content placements, content (e.g., creatives), bids, and selection criteria. Selection criteria can include, for example, a language, one or more geographical locations or websites, and/or one or more selection terms. The selection terms, can include, for example, one or more keywords. The selection terms can be used in evaluating when to serve content items in response to received requests for content.

The content management system 110 can identify, in the historical traffic database 122, historical traffic associated with a campaign of a particular content provider 108. As mentioned, the historical traffic can include data that is representative of occurrences of when an impression of campaign content was delivered in response to a received request. The historical traffic data can indicate a received query, any interaction with the content item, and conversion information associated with the impression. The content management system 110 can evaluate the historical traffic for the content provider 108 to identify one or more keyword independent signals or other signals that are statistically significant in terms of one or more metrics for measuring effectiveness of the campaign. The metrics can include, for example, click-through rate, conversion rate, etc. In some implementations, the metrics are determined, at least in part, by a simulator system 123.

A keyword independent signal can be a signal that can be determined from historical traffic but which cannot easily be directly expressed by the content provider 108 using keyword or other selection criteria. For example, a keyword independent signal can be associated with an abstraction or an intent that can be determined from the request but which differs/or puts in context the specific keywords that are associated with a given request. For example, a specific request may be assumed to be provided in a context. The context may be determined based on session information, location information or other information. The context may form the basis for the keyword independent signal. A keyword independent signal can be inferred/extracted from a query and other information relating to a context in which the query was submitted. For example a query can indicate an album A for a particular artist XYZ. A keyword independent signal can be derived from the query and be of the form of “queries that mention any album produced by the artist XYZ” or “intent to buy music of artist XYZ.” Such keyword independent signals, although abstractly related to the specific “album” that was searched for and included in the query, do not explicitly mention the artist XYZ. The system may determine that a particular campaign is more or less successful in particular context when such a query is received. Such a keyword based selection criteria may be difficult to construct by a content provider 108 in terms of conventional keywords. In general, signals that may be difficult for a content provider to express using available means of specifying selection criteria may be determined.

A keyword independent signal or other signal can be determined by evaluating request information included in the historical traffic (e.g., including keywords associated with the requests), to identify an abstraction, intent, or entity associated with the request. In some implementations, the keyword independent signal can itself be further abstracted and not mention the abstraction, intent, or entity specifically identified. For example, a review of the queries in the log may indicate several queries that searched for albums related to artist XYZ. The artist XYZ may be associated with a particular genre or time period. A further abstraction can be performed to derive a keyword independent signal relating to “music of the 70's” based on the inference “albums of artist XYZ” that has been itself abstracted from the set of evaluated queries.

As indicated above, other information (i.e., not just received queries) can be evaluated to determine a keyword independent signal. For example, the location of the requesting user device 106 or a user session associated with the request can be evaluated (where the location or session may provide a clue to the keyword independent signal, such as an intent to purchase. For example, a keyword independent signal of “the user session is primarily about traveling” can be identified.

The content management system 110 can identify keyword independent signals so as to surface such signals to the content provider 108. A keyword independent signal can be surfaced to the content provider 108, for example, as a natural language expression. For example, the content management system 110 can determine a natural language expression based on one or more of an abstraction, an intent, or an entity associated with a keyword independent signal. The natural language expression can describe the keyword independent signal to the content provider 108 in a natural (e.g., English) language.

A determined natural language expression 124 for a keyword independent signal can be presented to the content provider 108 (or content sponsor), such as in a campaign management user interface. The campaign management user interface can present the natural language expression in association with the campaign effectiveness metrics that were determined to be statistically significant when the historical traffic was evaluated. For example, the campaign management user interface can report that “your campaign has a 10% higher click-through rate when your campaign content is served in response to requests for content associated with queries that ‘mention an album produced by the artist XYZ’”. The campaign management user interface can also report on keyword independent signals that are determined to be associated with reduced campaign effectiveness.

The campaign management user interface can include one or more user interface controls with which the content provider 108 can specify a bid modifier to be applied when an incoming request for which the campaign is eligible satisfies the keyword independent signal associated with the presented natural language expression. For example, the content provider 108 can provide a bid modifier that raises or lowers a bid. The content management system 110 can receive a bid modifier 126 from the content provider and can store the bid modifier in association with the campaign, such as in the parameters datastore 121. The bid modifier 126 can be used in association with a real time occurrence of traffic that satisfies the associated keyword independent signal.

For example, in response to a received request for content, the content management system 110 can determine that an eligible content item is associated with a campaign that includes a selection criterion that requires satisfaction of a keyword independent signal. The content management system 110 can evaluate one or more of the request, a location of the requesting user device 106, or a session associated with the request to determine that the request satisfies the keyword independent signal. For example, the content management system 110 can determine an abstraction and/or an intent based on the request and other available information and determine that the abstraction and/or intent is indicative of the keyword independent signal.

The content management system 110 can retrieve a bid and a bid modifier associated with the eligible content item and apply the bid modifier to the bid to create a modified bid for the eligible content item. The modified bid for the eligible content item can be used in an auction with bids associated with other eligible content items. When the modified bid results in the eligible content item winning the auction, the content management system 110 can select the eligible content item for delivery responsive to the request. The content management system 110 can provide one or more user interfaces for content providers 108 to review reports 130 which report on performance of their content items for which bid modifiers have been applied, such as in comparison to other campaign content items for which bid modifiers have not been applied.

Although the above examples describe a modified bid being applied to a content item previously determined to be eligible, in some implementations, satisfaction of a keyword independent signal can be used, at least in part, to determine whether a content item is eligible to be served in response to a request. Other uses of the keyword independent signals are possible, such as in association with other suggestions to a particular content sponsor for adjusting, evaluating or creating a campaign.

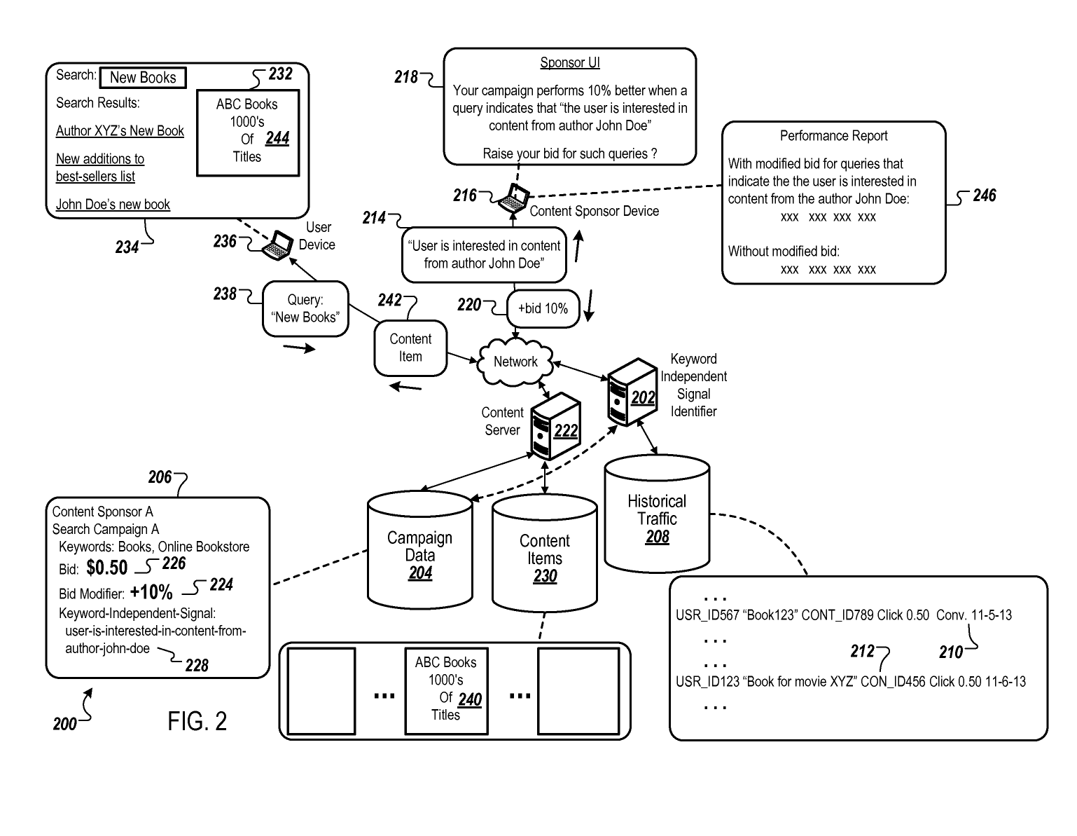

FIG. 2 is a block diagram of an example system 200 for determining and responding to keyword independent signals. A keyword independent signal identifier 202 can identify a “search campaign A” campaign for distributing content items associated with a content sponsor. The identified campaign can be identified, for example, from data in a campaign database 204. The identified campaign can include selection criteria for use in determining when to present content items for the campaign in response to received requests for content. For example, as illustrated by example campaign data 206, the selection criteria can include keywords, such as a “books” keyword and an “online bookstore” keyword.

The keyword independent signal identifier 202 can identify historical traffic associated with the identified campaign, such as from a historical traffic database 208. The historical traffic database 208 can include, for the identified campaign, data for impressions that have occurred for content items included in the identified campaign. For example, a row 210 includes an identifier of a presented content item (e.g., “CONT_ID789”), an identifier of the user device upon which the content item was presented (e.g., “USR_ID567”), a query associated with a request for content for which the content item was selected (e.g., “Book123”), a bid amount used in an auction (e.g., $0.50), a timestamp of the impression (e.g., 11-5-13), and indications of interactions with (e.g. “Click”) and conversions associated with the presented content item. A row 212 includes similar information for a different impression.

The keyword independent signal identifier 202 can evaluate the identified historical traffic including attending information related to the traffic to identify at least one keyword independent signal that is statistically significant in terms of one or more metrics for measuring effectiveness of the identified campaign. The keyword independent signal identifier 202 can, for a given traffic item such as the row 210 or the row 212, evaluate one or more of the received query, a location of the requesting user device, or a session in which the query was submitted.

The keyword independent signal identifier 202 can, for example, determine an abstraction, one or more entities, and/or an intent from the received query (and from other information). For example, for the row 210, which includes the received query of “Book123” (e.g., where “Book123” is a title of a particular book), the keyword independent signal identifier 202 can determine abstractions or entities of the book “Book123”, the author of the “Book123” book (e.g., author John Doe), a genre of literature that is associated with the book, and other abstractions or entities. Similarly, for the row 212, which includes the received query “book used for movie XYZ”, the keyword independent signal identifier 202 can identify abstractions or entities including the movie “XYZ”, a particular book (e.g., “Book234”) which was used for the movie “XYZ”, the author of the identified book (e.g., author John Doe), and other abstractions or entities. In some implementations, the keyword independent signal identifier 202 can determine abstractions or entities associated with a received query based on a plurality of received queries that were submitted or other actions by a same user device during a same session.

The keyword independent signal identifier can infer or determine an intent based on a received query and/or on a plurality of received queries received during a same session. For example, based on the received query “Book123” and/or the received query “Book used for movie XYZ”, and, for example, on a conversion event associated with the row 210, the keyword independent signal identifier 202 can determine that the row 210 and/or the row 212 is associated with an intent of the user being interested in content from author John Doe or more specifically interested in purchasing content by author John Doe. The keyword independent signal identifier 202 can determine that “the user being interested in content from author John Doe” is a description of a keyword independent signal that can be associated with the row 210 and/or the row 212 and possibly one or more other items in the historical traffic database 208.

The keyword independent signal identifier 202 can identify other signals that are associated with one or more items in the historical traffic database 208. For each identified keyword independent signal, the keyword independent signal identifier 202 can determine one or more campaign effectiveness metrics that are associated with the items in the historical traffic database 208 that are associated with the respective keyword independent signal. For example, the keyword independent signal identifier 202 can identify one hundred items (e.g., including the rows 210 and 212 and other rows) in the historical traffic database 208 that are associated with the keyword independent signal described by “the user being interested in content from author John Doe”. The keyword independent signal identifier 202 can determine, for example, click-through rate, cost per click, conversion rate, and/or other metrics for the items that are associated with a particular keyword independent signal.

The keyword independent signal identifier 202 can select one or more top keyword independent signals for surfacing to the content sponsor of the identified campaign, in terms of one or more campaign effectiveness metrics. For example, the keyword independent signal identifier 202 can compare one or more campaign effectiveness metrics for a keyword independent signal to corresponding one or more campaign effectiveness metrics associated with the campaign in general. For example, the keyword independent signal identifier 202 can determine (or access) one or more campaign effectiveness metrics for the identified campaign (e.g., corresponding to all items in the historical traffic database 208 that are associated with the identified campaign).

The keyword independent signal identifier 202 can, for example, determine and select a top N (e.g., five) highest keyword independent signals or the top M signals that differ the most from the identified campaign in general in terms of one or more corresponding metrics. For example, five keyword independent signals can be selected that have the five highest differences in click-through rate, conversion rate, cost, or other metric as compared to values for corresponding metrics for the campaign in general. As another example, each keyword independent signal that has one or more metrics that are at least a threshold different (e.g., ten percent different) than a corresponding metric for the campaign in general can be selected. Keyword independent signals that have metrics that are higher and/or lower than corresponding metrics for the campaign in general can be selected.

The keyword independent signal identifier 202 can determine a natural language expression for each selected keyword independent signal. For example, as mentioned above, a natural language expression of “the user is interested in content from author John Doe” can describe a selected keyword independent signal. A natural language expression can be determined, for example, from one or more of an abstraction, an entity, or an intent that is associated with a selected keyword independent signal.

A determined natural language expression for each selected keyword independent signal can be presented to the content sponsor. For example, a natural language expression 214 of “user is interested in content from author John Doe” can be presented on a content sponsor user device 216, as illustrated in a user interface 218. The user interface 218 can present a current bid for the campaign and can suggest a modified bid which represents a bid modifier to be used in association with a real time occurrence of traffic that satisfies the keyword independent signal described by the natural language expression 214. The content sponsor can accept or reject the suggested bid modifier or can provide a different bid modifier. In either case, a bid modifier 220 may be received, such as by the keyword independent signal identifier 202 and/or a content server 222.

The received bid modifier 220 can be stored in association with the campaign. For example, as shown in the example campaign data 206, a bid modifier 224 corresponding to the received bid modifier 220 is stored in association with the “search campaign A” campaign and in association with a bid 226 and data 228 which describes and/or defines a keyword independent signal corresponding to the presented natural language expression 214.

The content server 222 can, after the bid modifier 224 is stored, receive a request for content that includes one or more keywords for use in determining eligible content items from an inventory 230 of available content items. For example, the content server 220 can receive a request for content for a content slot 232 included in a search results page 234 that is to be provided to a user device 236 in response to a search query 238 of “new books”. The content server 222 can, as part of evaluating the inventory 230 in response to the request associated with the query 238, compare one or more keywords associated with the request 238 (e.g., “books”) to selection keywords that are associated with each available content item in the inventory 230. For example, a “books” keyword associated with the “search campaign A” campaign can be identified as a match of the “books” keyword included in the request associated with the query 238. The content server 222 can identify a content item 240 in the inventory 230 as an eligible content item based on identifying the “search campaign A” campaign as matching a request keyword and based on the content item 240 being associated with the “search campaign A” campaign.

The content server 222 can determine that “search campaign A” includes a selection criterion that requires satisfaction of a keyword independent signal associated with the data 228. The content server 222 can evaluate one or more of the request associated with the query 238, a location of the user device 236, or a session associated with the request to determine that the request satisfies the keyword independent signal associated with the data 228. For example, a session associated with the request can include other requests that indicate that the user of the user device 236 is interested in content associated with the author John Doe. As another example, the content server 222 can determine that the query 238 includes abstractions of “books” and “new books” and can determine that the author John Doe has recently released a new book. The content server 222 can determine that the query 238 indicates an intent to find content from the author John Doe. Other approaches can be used for determining that the request satisfies the keyword independent signal associated with the data 228.

Based on determining that the request associated with the query 238 satisfies the keyword independent signal associated with the data 228, the content server 222 can retrieve the bid modifier 224 and apply the bid modifier 224 to the bid 226 to create a modified bid (e.g., a modified bid of $0.55). The modified bid can be used in an auction with bids associated with other eligible content items. When the modified bid results in the content item 240 winning the auction, the content item 240 can be selected for delivery responsive to the request based on the results of the auction. For example, the content item 240 can be provided to the user device 236 (e.g., as illustrated by a provided content item 242) for presentation in the content slot 232 (e.g., as illustrated by a presented content item 244).

The content sponsor can view performance information related to performance of campaign content items selected with a modified bid as compared to campaign content items selected without a modified bid. For example, a performance report 246 can be presented on the content sponsor user device 216. The performance report 246 can include, for example, keyword-independent-signal-related campaign effectiveness metrics (e.g., click through rate, conversion rate, etc.) for content items selected when the respective content item participated in and won (or lost) an auction with a bid modified due to identification of the keyword independent signal associated with the data 228. The keyword-independent-signal-related metrics can be compared to metrics associated with presentation of campaign content items selected without a bid being modified due to identification of a keyword independent signal.

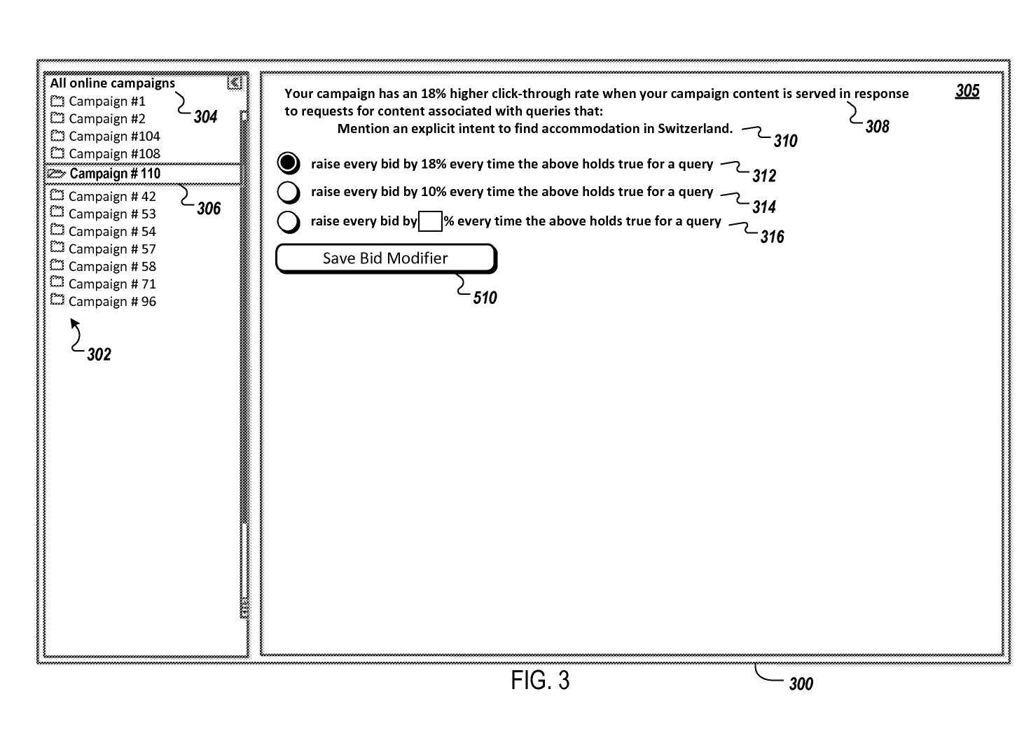

FIG. 3 illustrates an example campaign management user interface 300. The user interface 300 can be included, for example, in one or more user interfaces that a user, such as a campaign sponsor, can use to configure a campaign. The sponsor can view a list 302 of campaigns by selecting a control 304. The sponsor can configure an existing campaign in a campaign configuration area 305 by selecting the name of an existing campaign (e.g., a name 306) in the campaign list 302.

The campaign configuration area 305 includes a message 308 which indicates that the selected campaign has an 18% higher click-through rate when the campaign content for the selected campaign is served in response to requests for content associated with queries that mention an explicit intent to find accommodation in Switzerland. The message 308 includes a natural language expression 310 of “mentions an explicit intent to find accommodation in Switzerland” which describes the associated keyword independent signal. The campaign configuration area 305 includes user interface controls 312, 314, and 316 which allow the content sponsor to configure the campaign such that a modified bid of a bid increase of eighteen, ten, or a sponsor-specified percent, respectively, is used in association with a real time occurrence of campaign traffic that satisfies the keyword independent signal associated with the natural language expression 310.

Although one natural language expression 310 is displayed in the campaign configuration area 305, in some implementations, multiple natural language expressions can be presented. For example, a set of natural language expressions can be presented where the natural language expressions are respectively associated with a set (e.g., ten) of the most statistically significant keyword independent signals in terms of one or more metrics for measuring effectiveness of the campaign. In such examples, the content sponsor can configure a bid modifier for one or more of the keyword independent signals associated with the presented natural language expressions.

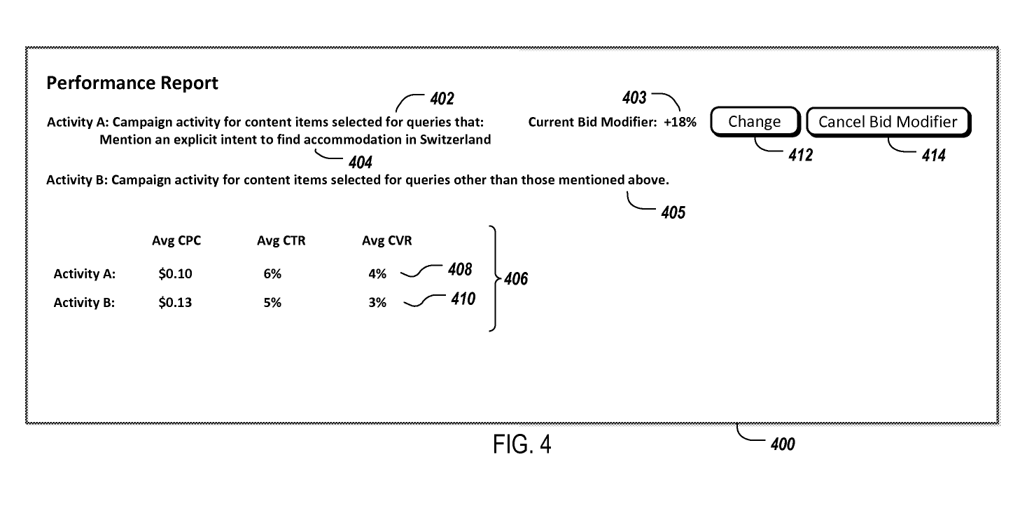

FIG. 4 illustrates an example performance report 400 for campaign activity associated with a keyword independent signal. The performance report 400 includes a label 402 that defines “activity A” as “campaign activity for content items selected for queries that ‘mention an explicit intent to find accommodation in Switzerland’” for which a bid modifier 403 has been applied. For example, campaign activity “A” is activity associated with a keyword independent signal that is described by a natural language expression “mentions an explicit intent to find accommodation in Switzerland” 404. A label 405 defines “activity B” as campaign activity for content items selected for queries that don't satisfy the keyword independent signal described by the natural language expression 404.

A performance area 406 shows performance statistics (e.g., for a latest report period, such as the last week, last month, etc.) for activity “A” and activity “B”. For example, a row 408 for activity “A” indicates that an average Cost Per Click (CPC) was $0.10, an average Click Through Rate (CTR) was 6%, and an average conversion rate (CVR) was 4%, for campaign activity for content items selected for queries that ‘mention an explicit intent to find accommodation in Switzerland’ for which the bid modifier 403 was applied. A row 410 for activity “B” indicates that an average CPC was $0.13, an average CTR was 5%, and an average CVR was 3% for campaign activity for which the keyword independent signal associated with the natural language expression 404 was not satisfied. Accordingly, the bid modifier 403 was not applied for such activity. After reviewing the report 400, the content sponsor can choose to leave the bid modifier 403 applied and unchanged, change the bid modifier 403 (e.g., to a different percentage) using a user interface control 412, or cancel (e.g., unapply) the bid modifier 403 using a user interface control 414.

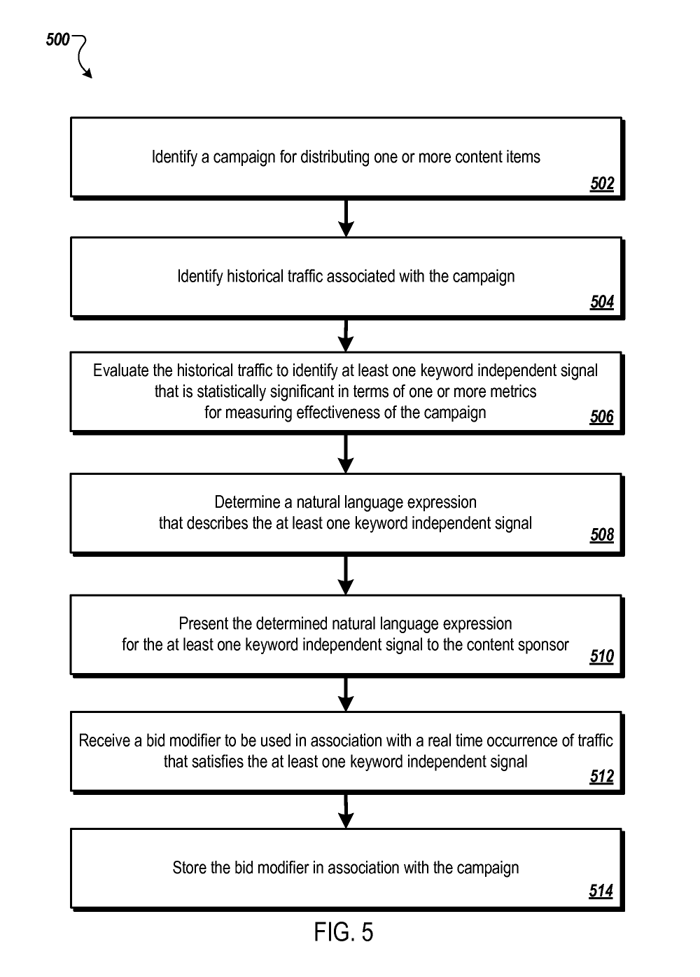

FIG. 5 is a flowchart of an example process 500 for presenting information for keyboard independent signals to a content sponsor. The process 500 can be performed, for example, by the content management system 110 described above with respect to FIG. 1 and/or the keyword independent signal identifier 202 described above with respect to FIG. 2.

A campaign for distributing one or more content items is identified (502). The campaign can be associated with a content sponsor and can have selection criteria for use in determining when to present the one or more content items in response to received requests for content. The selection criteria can include a plurality of keywords. The content items can be advertisements or some other type of content. The content sponsor can be, for example, an advertiser or some other type of content sponsor.

Historical traffic associated with the campaign is identified (504). The historical traffic can be representative of occurrences of when an impression of one of the one or more content items was delivered in response to a received request for content. The historical traffic can include, for an impression, data that indicates a received query, any interaction, and conversion information associated with the impression. Historical traffic can be, for example, log data.

The historical traffic is evaluated to identify at least one keyword independent signal that is statistically significant in terms of one or more metrics for measuring effectiveness of the campaign (506). Example keyword independent signals are described below and also in association with FIG. 1 through FIG. 4. Statistical significance can be determined, for example, by using a Fisher's exact test or a Pearson chi-square test. For a given traffic item, one or more of the received query, a location of the requesting device, or a session in which the query was submitted can be evaluated to identify one or more keyword independent signals. For example, an intent associated with the received query can be determined and the intent can be identified as being associated with a keyword independent signal. As another example, an abstraction can be determined and the abstraction can be identified as being associated with a keyword independent signal.

In some implementations, a plurality of abstractions and/or a plurality of intents are determined, wherein each abstraction or intent is associated with a query submitted by a user during a session associated with the received query. A keyword independent signal associated with the received query can be determined based on one or more of the plurality of abstractions and intents associated with queries other than the received query, an abstraction associated with the receive query, or an intent associated with the received query.

A natural language expression that describes the at least one keyword independent signal is determined (508). The natural language expression can be determined, for example, from one or more of an abstraction, an entity, or an intent that is associated with a corresponding keyword independent signal. Specific examples of natural language expressions that can be determined for corresponding keyword independent signals include “the query is correctly spelled”, “the query contains the entity for New York City”, “the query mentions an album produced by the record company XXX”, “the query seeks cheap flights within the United States”, “the explicit intent of the user appears to be watching or downloading digital content”, “the user session is primarily about travelling”, “the query explicitly mentions an album by artist ZZZ”, and “the query mentions an intent to find accommodations in Switzerland”. Similar and other natural language expressions can be determined for other determined keyword independent signals.

Identification of a keyword independent signal can include identifying an entity associated with a query when the query does not include a proper name of the entity but includes other information which identifies the entity. For example, a keyword independent signal of “the query includes the entity for New York City” can be determined by identifying query keywords or other entities that are associated with the entity New York City. Determining a natural language expression for such a keyword independent signal can include concatenating hard-coded text of “the query includes the entity for” with a display name of the entity (e.g., “New York City”).

Identification of a keyword independent signal can include identifying properties of an entity included in a query and/or relationships between multiple entities each associated with a query. For example, a knowledge graph may include a definition of a class of entity for a record company entity type and may include an instance of the record company entity for a particular record company named “XXX Records”. The knowledge graph may define a relationship between the record company entity and an album entity (in some implementations, “album” may be defined as a property of the record-company entity). For example, the relationship between a record company and an album can be defined or modeled using patterns such as “<record-company> produces <album>” or “<album> is-produced-by <record-company>”. For a given record company such as “XXX Records”, the knowledge graph can include, for each album produced by the record company, an association between the record company and the album. The evaluation of historical traffic can include identifying multiple queries that mention an album produced by “XXX Records without explicitly mentioning “XXX Records”, identifying a keyword independent signal associated with such queries, and identifying an entity relationship type in the knowledge graph between a record company entity and an album entity. A natural language expression can be determined for such a signal by including literal text (e.g., “the query mentions”) along with phrases derived from display names of the entities included in the entity relationship (e.g., “album”, “record company”), and a display name associated with the relationship itself (e.g., “produced by”). For example, a natural language expression of “the query mentions an album produced by the record company XXX” can be determined.

A keyword independent signal can be determined based on identifying a user intent. For example, an intent of “the query seeks cheap flights within the United States” or “the explicit intent of the user appears to be watching or downloading digital content” can be determined. Intents can be modeled using a natural language grammar. For example, a natural language parser that parses a query to infer a query intent can be configured to recognize queries of a particular structure as being associated with a particular type of intent. For example, travel-intent queries can be associated with a particular type of structure. For example, a travel-intent structure can be defined as a query in which two geographic locations are mentioned in a particular configuration together with travel-related terms and specific prepositions such as in a phrase of ‘flight from A to B’.” A natural language expression can be associated with a particular intent and can be retrieved when the particular intent is inferred.

The determined natural language expression for the at least one keyword independent signal is presented to the content sponsor (510). For example, the natural expression can be presented in an interface to the sponsor as part of a campaign modification tool.

In some implementations, a bid associated with the campaign is evaluated based on the keyword independent signal to create a bid modifier suggestion for the keyword independent signal. For example, a bid modifier suggestion can correspond to a difference between a campaign effectiveness metric for impressions of campaign content items when the keyword independent signal was satisfied to a corresponding campaign effectiveness metric for impressions of campaign content items when the keyword independent signal was not satisfied. For example, a suggested bid modifier of 10% may be determined when a determination is made that a click-through rate was 10% higher when a keyword independent signal was satisfied as compared to when the keyword independent signal was not satisfied. When a suggested bid modifier is determined for a keyword independent signal, the suggested bid modifier can be presented with the natural language expression that describes the keyword independent signal.

In situations when a plurality of keyword independent signals are determined, a suggested bid modifier can be determined for each keyword independent signal. A natural language expression and a suggested bid modifier can be presented for each of a set of top ranked keyword independent signals.

A bid modifier to be used in association with a real time occurrence of traffic that satisfies the at least one keyword independent signal is received (512). For example, a bid modifier can be received for some or all presented natural language expressions. For a particular natural language expression, a suggested bid modifier can be received (e.g., unchanged from a suggested value). As another example, a sponsor-provided bid modifier can be received, such as a bid modifier for a natural language expression for which no suggested bid modifier is presented, or as a sponsor-provided bid modifier that is an alternative to a suggested bid modifier.

The bid modifier is stored in association with the campaign (514). For example, the bid modifier can be stored, in association with some or all of the bid, the natural language expression, and other data associated with the keyword independent signal.

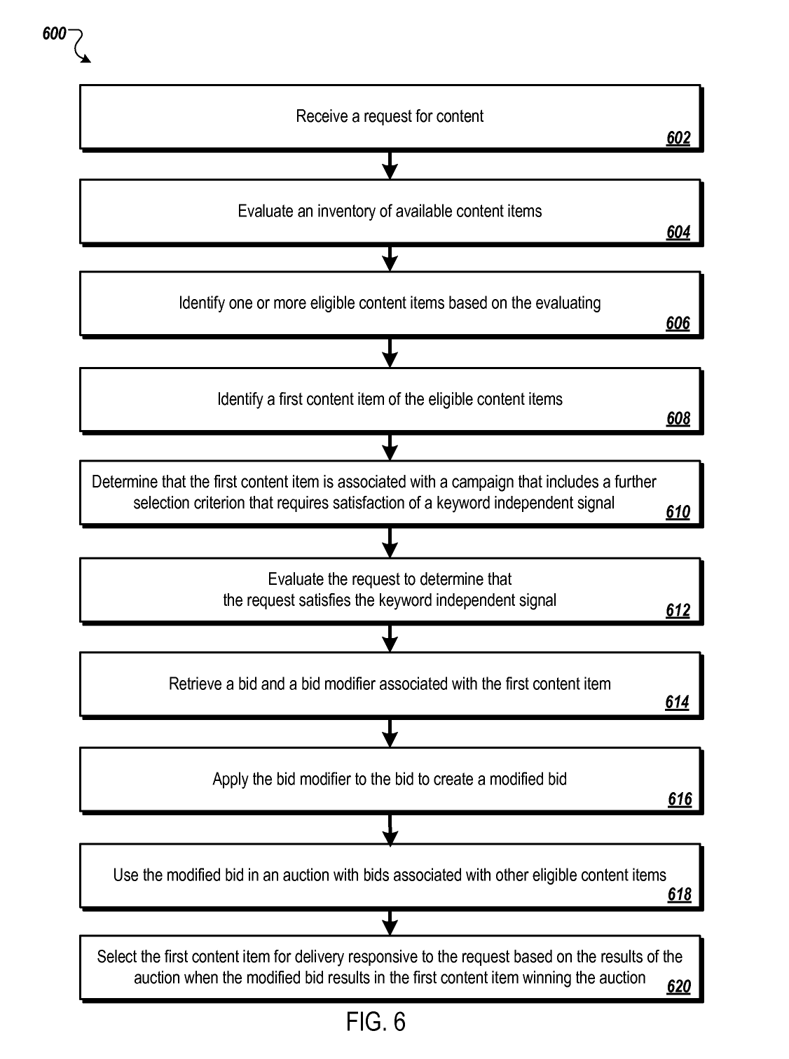

FIG. 6 is a flowchart of an example process 600 for applying a bid modifier associated with a keyword independent signal. The process 600 can be performed, for example, by the content management system 110 described above with respect to FIG. 1 and/or the content server 222 described above with respect to FIG. 2.

A request for content is received (602). The request can include one or more keywords for use in determining eligible content items from an inventory of available content items. The inventory can be an inventory of advertisements and/or other types of content items. The keywords can be, for example, search terms or keywords associated with a resource in which the requested content is to be presented.

The inventory is evaluated (604), including comparing the one or more keywords included in the request to one or more selection keywords that are associated with each available content item in inventory. For example, a degree of match between the request keywords and the selection keywords can be determined.

One or more eligible content items are identified based on the evaluating (606). For example, one or more content items having the highest determined degree of match can be identified.

A first content item of the eligible content items is identified (608), including determining that the first content item is a match for the request based on the one or more keywords and selection keywords associated with the first content item. The first content item can, for example, have a highest degree of match among the eligible content items.

A determination is made that the first content item is associated with a campaign that includes a further selection criterion that requires satisfaction of a keyword independent signal (610). For example, the association of the first content item and the further selection criterion to the campaign can be determined by querying a campaign data database.

The request is evaluated to determine that the request satisfies the keyword independent signal (612). For example, one or more of the request, a location of the requesting user device, or a session associated with the request can be evaluated to determine that the request satisfies the keyword independent signal. Other examples include determining an abstraction and/or an intent based on the request matching the abstraction and/or intent to one or more abstractions and/or intents associated with the keyword independent signal.

A bid and a bid modifier associated with the first content item are retrieved (614). For example, the bid and the bid modifier can be retrieved from campaign data associated with the campaign.

The bid modifier is applied to the bid to create a modified bid (616). For example, the bid modifier can raise or lower the bid, by an absolute or relative amount.

The modified bid is used in an auction with bids associated with other eligible content items (618). For example, the modified bid can be used in the auction to determine whether the first content item is a winner of the auction.

The first content item is selected for delivery responsive to the request based on the results of the auction when the modified bid results in the first content item winning the auction (620). The first content item can be provided, for example, to the requesting user device. Data can be recorded (e.g., in a log) that indicates that the first content item was provided when the modified bid associated with the keyword independent signal was a winning bid for the auction.

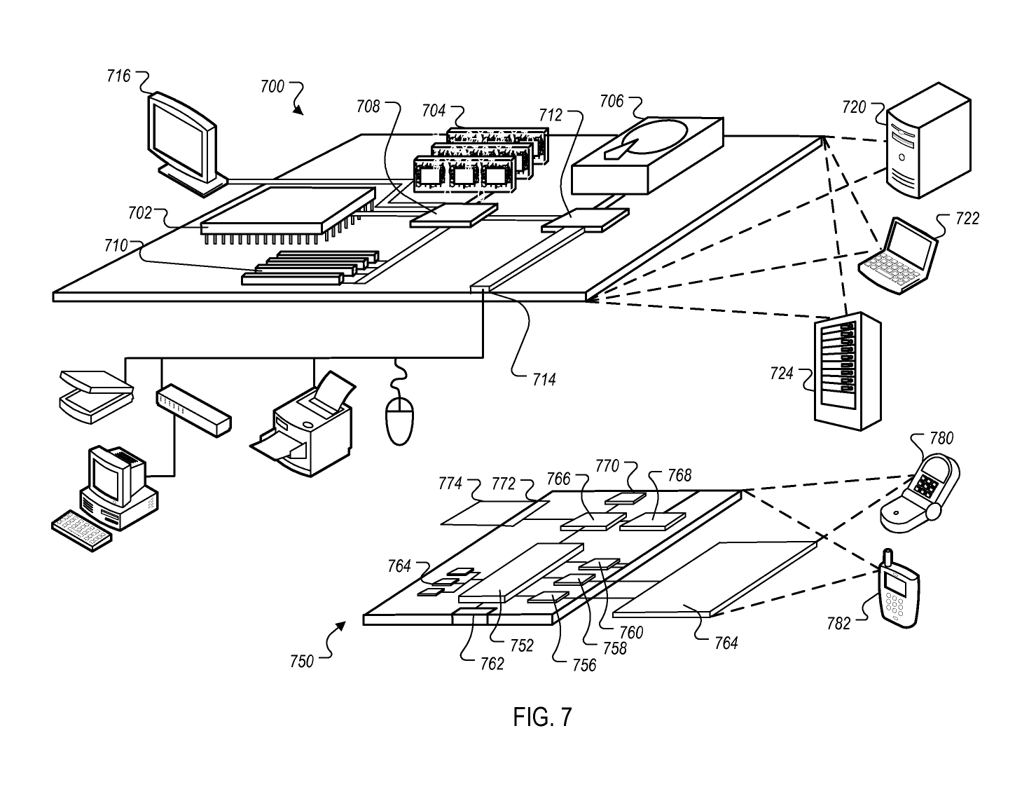

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. The computer-readable medium is not a propagating signal. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of duties is illustrative only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth® or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth®, WiFi, or other such transceiver (not shown). In addition, GPS receiver module 770 may provide additional wireless data to device 750, which may be used as appropriate by applications running on device 750.

Device 750 may also communicate audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
identifying a campaign for distributing one or more content items, the campaign being associated with a content sponsor and having selection criteria for use in determining when to present the one or more content items in response to received requests for content, wherein the selection criteria includes a plurality of keywords;
identifying historical traffic associated with the campaign, the historical traffic representative of occurrences of when an impression of one of the one or more content items was delivered in response to a received request, the historical traffic including data that indicates a received query, any interaction and conversion information associated with the impression;
evaluating the historical traffic to identify at least one keyword independent signal that is statistically significant in terms of one or more metrics for measuring effectiveness of the campaign;
determining a natural language expression that describes the at least one keyword independent signal;
presenting the determined natural language expression for the at least one keyword independent signal to the content sponsor;
receiving a bid modifier to be used in association with a real time occurrence of traffic that satisfies the at least one keyword independent signal; and
storing the bid modifier in association with the campaign.

2. The method of claim 1 wherein the campaign is an advertisement campaign and the natural language expression is presented in an interface to an advertiser associated with the campaign as part of a campaign modification tool.

3. The method of claim 1 wherein evaluating the historical traffic includes, for a given traffic item, evaluating one or more of the received query, a location of the requesting device, or a session in which the query was submitted.

4. The method of claim 1 wherein evaluating the historical traffic includes determining an abstraction from the received query and using the abstraction to determine the natural language expression.

5. The method of claim 4 wherein evaluating the historical traffic includes determining a plurality of abstractions each associated with a query submitted by a user during a session associated with the received query and wherein determining a natural language expression further includes determining a common abstraction from the determined plurality of abstractions.

6. The method of claim 1 wherein evaluating the historical traffic includes determining an intent associated with the received query and wherein determining a natural language expression further includes using the intent to determine the natural language expression.

7. The method of claim 6 wherein evaluating the historical traffic includes determining a plurality of intents each associated with a query submitted by a user during a session associated with the received query and wherein determining a natural language expression further includes determining a common intent from the determined plurality of intents.

8. The method of claim 1 wherein the bid modifier is an adjustment to a bid that is to be applied to a single auction in which the selection criteria have determined to be satisfied along with the determined natural language expression.

9. The method of claim 1 further comprising evaluating a bid associated with the campaign based on the keyword independent signal, creating a suggestion for the bid modifier, and presenting the bid modifier suggestion along with the natural language expression.

10. The method of claim 9 further comprising identifying a plurality of keyword independent signals, determining bid modifiers for each and presenting natural language expressions for top ranked keyword independent signals and associated bid modifier suggestions for each.

11. A method comprising:
receiving a request for content, the request including one or more keywords for use in determining eligible content items from an inventory of available content items;
evaluating the inventory including comparing the one or more keywords to selection keywords that are associated with each available content item in inventory;
identifying one or more eligible content items based on the evaluating;
identifying a first content item of the eligible content items including determining that the first content item is a match for the request based on the one or more keywords and selection keywords associated with the first content item;
determining that the first content item is associated with a campaign that includes a further selection criterion that requires satisfaction of a keyword independent signal;
evaluating the request to determine that the request satisfies the keyword independent signal;
retrieving a bid and a bid modifier associated with the first content item;
applying the bid modifier to the bid to create a modified bid;
using the modified bid in an auction with bids associated with other eligible content items; and
selecting the first content item for delivery responsive to the request based on the results of the auction when the modified bid results in the first content item winning the auction.

12. The method of claim 11 wherein evaluating the request includes evaluating one or more of the request, a location of a requesting device, or a session associated with the request.

13. The method of claim 12 wherein evaluating the request includes determining an abstraction based on the request and using the abstraction to determine satisfaction of the keyword independent signal.

14. The method of claim 12 wherein evaluating the request includes determining an intent based on the request and using the intent to determine satisfaction of the keyword independent signal.

15. The method of claim 11 further comprising storing modified bid use information that describes the use of the modified bid.

16. The method of claim 15 further comprising providing a report that includes the modified bid use information to a content sponsor associated with the campaign.

17. The method of claim 16 wherein the report includes selectable controls for increasing, decreasing, or deselecting a bid modifier.

18. The method of claim 17 further comprising receiving an indication of a selected control and applying a corresponding action to the bid modifier based on the indication.

19. A computer program product tangibly embodied in a computer-readable storage device and comprising instructions that, when executed by a processor, cause the processor to:
identify a campaign for distributing one or more content items, the campaign being associated with a content sponsor and having selection criteria for use in determining when to present the one or more content items in response to received requests for content, wherein the selection criteria includes a plurality of keywords;
identify historical traffic associated with the campaign, the historical traffic representative of occurrences of when an impression of one of the one or more content items was delivered in response to a received request, the historical traffic including data that indicates a received query, any interaction and conversion information associated with the impression;
evaluate the historical traffic to identify at least one keyword independent signal that is statistically significant in terms of one or more metrics for measuring effectiveness of the campaign;
determine a natural language expression that describes the at least one keyword independent signal;
present the determined natural language expression for the at least one keyword independent signal to the content sponsor;
receive a bid modifier to be used in association with a real time occurrence of traffic that satisfies the at least one keyword independent signal; and
store the bid modifier in association with the campaign.

20. A system comprising:
one or more processors; and
one or more memory elements including instructions that when executed cause the one or more processors to:
identify a campaign for distributing one or more content items, the campaign being associated with a content sponsor and having selection criteria for use in determining when to present the one or more content items in response to received requests for content, wherein the selection criteria includes a plurality of keywords;
identify historical traffic associated with the campaign, the historical traffic representative of occurrences of when an impression of one of the one or more content items was delivered in response to a received request, the historical traffic including data that indicates a received query, any interaction and conversion information associated with the impression;
evaluate the historical traffic to identify at least one keyword independent signal that is statistically significant in terms of one or more metrics for measuring effectiveness of the campaign;
determine a natural language expression that describes the at least one keyword independent signal;
present the determined natural language expression for the at least one keyword independent signal to the content sponsor;
receive a bid modifier to be used in association with a real time occurrence of traffic that satisfies the at least one keyword independent signal; and
store the bid modifier in association with the campaign.

21. A computer program product tangibly embodied in a computer-readable storage device and comprising instructions that, when executed by a processor, cause the processor to:
receive a request for content, the request including one or more keywords for use in determining eligible content items from an inventory of available content items;
evaluate the inventory including comparing the one or more keywords to selection keywords that are associated with each available content item in inventory;
identify one or more eligible content items based on the evaluating;
identify a first content item of the eligible content items including determining that the first content item is a match for the request based on the one or more keywords and selection keywords associated with the first content item;
determine that the first content item is associated with a campaign that includes a further selection criterion that requires satisfaction of a keyword independent signal;
evaluate the request to determine that the request satisfies the keyword independent signal;
retrieve a bid and a bid modifier associated with the first content item;
apply the bid modifier to the bid to create a modified bid;
use the modified bid in an auction with bids associated with other eligible content items; and
select the first content item for delivery responsive to the request based on the results of the auction when the modified bid results in the first content item winning the auction.

22. A system comprising:
one or more processors; and
one or more memory elements including instructions that when executed cause the one or more processors to:
receive a request for content, the request including one or more keywords for use in determining eligible content items from an inventory of available content items;
evaluate the inventory including comparing the one or more keywords to selection keywords that are associated with each available content item in inventory;
identify one or more eligible content items based on the evaluating;
identify a first content item of the eligible content items including determining that the first content item is a match for the request based on the one or more keywords and selection keywords associated with the first content item;
determine that the first content item is associated with a campaign that includes a further selection criterion that requires satisfaction of a keyword independent signal;
evaluate the request to determine that the request satisfies the keyword independent signal;
retrieve a bid and a bid modifier associated with the first content item;
apply the bid modifier to the bid to create a modified bid;
use the modified bid in an auction with bids associated with other eligible content items; and
select the first content item for delivery responsive to the request based on the results of the auction when the modified bid results in the first content item winning the auction.
